(19) United States
(12) Patent Application Publication
(10) Pub. No.: US 2015/0314647 A1
(43) Pub. Date: Nov. 5, 2015

(54) Pneumatic Radial Tire

(71) Applicant: THE YOKOHAMA RUBBER CO., LTD., Minato-ku, Tokyo (JP)

(72) Inventors: Hiroshi Kakizawa, Hiratsuka-shi, Kanagawa (JP); Yoshio Ueda, Hiratsuka-shi, Kanagawa (JP)

(73) Assignee: The Yokohama Rubber Co. LTD., Minato-ku, Tokyo (JP)

(21) Appl. No.: 14/369,150

(22) PCT Filed: Dec. 26, 2012
(86) PCT No.: PCT/JP2012/008337

§ 371 Date: Jun. 26, 2014

(30) Foreign Application Priority Data
Dec. 26, 2011 (JP) 2011-283016

(51) Int. Cl. B60C 9/00; B60C 9/20; B60C 5/00

(52) U.S. Cl. CPC B60C 9/0007; B60C 5/00; B60C 9/0064; B60C 9/20; B60C 9/2006; B60C 2009/0071; B60C 2009/0092; B60C 2009/2048; B60C 2009/2077; B60C 2009/2096

(57) ABSTRACT

A pneumatic radial tire includes: a pair of bead portions; a pair of side wall portions; and a tread portion in which a carcass layer is mounted between the pair of bead portions, and a belt layer that includes a plurality of monofilament steel wires laid in parallel and embedded in rubber is disposed between the pair of side wall portions on an outer circumferential side in the tread portion. The wire strand diameter of the monofilament steel wires is from 0.30 mm to 0.40 mm, each of the monofilament steel wires is twisted around their axial direction with a wire surface twisting angle of 1° to 15° with respect to the axial direction of the monofilament steel wires, and the surface residual stress of the monofilament steel wires is 0 MPa or less.

### TECHNICAL FIELD

The present technology relates to a pneumatic radial tire that includes a belt layer in which a plurality of monofilament steel wires is laid in parallel and embedded in rubber.

### BACKGROUND TECHNOLOGY

Conventionally, steel cords in which a plurality of filaments is twisted together are used as the reinforcing cords of the belt layer of a pneumatic radial tire. However, the cord diameter of steel cords in which a plurality of filaments is twisted together increases due to internal gaps formed between filaments, so a large quantity of coating rubber is required, and the rolling resistance of the pneumatic radial tire can easily increase.

Therefore, the use of monofilament steel wires as reinforcing cords of the belt layer has been proposed in order to reduce the coating rubber in the belt layer and to reduce the rolling resistance of the pneumatic radial tire (for example, see Japanese Unexamined Patent Application Publication Nos. H4-95506A, 2006-218988A and 2010-89727A). In this case, it is necessary to increase the strength of the monofilament steel wires sufficiently by wire drawing in order to ensure sufficient reinforcement effect of the monofilament steel wires. However, drawn monofilament steel wire contacts the wire drawing die during processing, which produces excessive orientation of the metal microstructure which increases the closer to the surface side of the wire. Therefore, if this monofilament steel wire is used as it is as the reinforcing cords of the belt layer, then, for example, if buckling occurs in the tread portion at the boundary of a circumferential main groove, bending damage will be caused to the monofilament steel wires, which produces the problem that the tire durability performance is reduced.

### SUMMARY

The present technology provides a pneumatic radial tire that includes a belt layer in which a plurality of monofilament steel wires is laid in parallel and embedded in rubber, and that can reduce the rolling resistance while maintaining excellent tire durability performance.

The pneumatic radial tire of the present technology includes:

a pair of bead portions;

a pair of side wall portions; and

a tread portion in which a carcass layer is mounted between the pair of bead portions, and a belt layer that includes a plurality of monofilament steel wires laid in parallel and embedded in rubber is disposed between the pair of side wall portions on the outer circumferential side in the tread portion, wherein

the wire strand diameter of the monofilament steel wires is from 0.30 mm to 0.40 mm,

each of the monofilament steel wires is twisted around their axial direction, with a wire surface twisting angle of 1° to 15° with respect to the axial direction of the monofilament steel wires, and

the surface residual stress of the monofilament steel wires is 0 MPa or less.

### BRIEF DESCRIPTION OF THE DRAWINGS

FIG. 1 is a half cross-sectional view taken along a meridian illustrating a pneumatic radial tire according to an embodiment of the present technology.

FIG. 2 is a side view illustrating a monofilament steel wire used in a belt layer in the present technology.

FIG. 3 is a side view illustrating a monofilament steel wire illustrating a portion of FIG. 2 enlarged.

### DETAILED DESCRIPTION

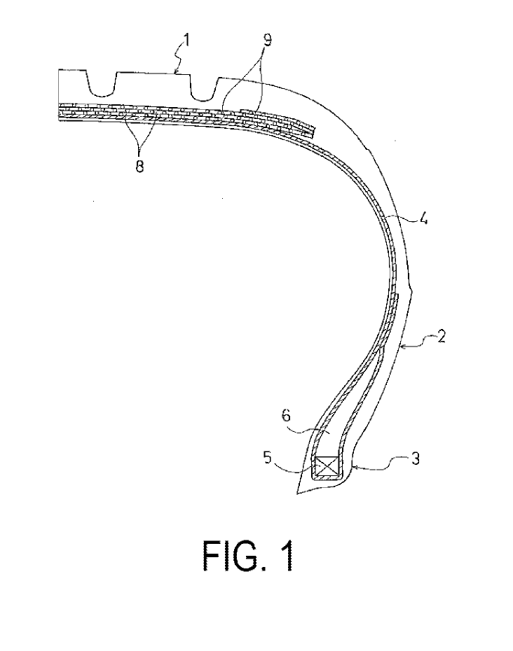

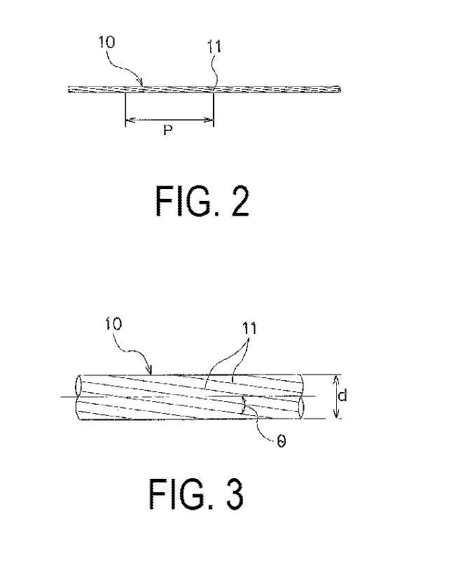

Detailed descriptions will be given below of a configuration of the present technology with reference to the accompanying drawings. FIG. 1 illustrates a pneumatic radial tire according to an embodiment of the present technology, and FIGS. 2 and 3 illustrate a monofilament steel wire used in a belt layer in the present technology.

In FIG. 1, 1 is a tread portion; 2 is a side wall portion; and 3 is a bead portion. A carcass layer 4 is mounted between the pair of left and right bead portions 3, 3 (one side only illustrated in FIG. 1). The carcass layer 4 includes a plurality of reinforcing cords extending in the tire radial direction, and is folded back around a bead core 5 disposed in each of the bead portions 3 from a tire inner side to a tire outer side. Generally, organic fiber cords are used as the reinforcing cords of the carcass layer 4, but steel cords may be used. A bead filler 6 is disposed on a periphery of the bead core 5, and the bead filler 6 is enveloped by a main body part and the folded over part of the carcass layer 4.

On the other hand, a belt layer 8 having a plurality of layers disposed between the pair of side wall portions 2, 2 is embedded on the outer circumferential side of the carcass layer 4 in the tread portion 1 (one side only illustrated in FIG. 1). The belt layers 8 include a plurality of reinforcing cords disposed at an inclination with respect to the tire circumferential direction, the reinforcing cords are disposed between the layers so as to intersect each other, in other words, the reinforcing cords are disposed with different inclination angles with respect to the tire circumferential direction. In the belt layers 8, an inclination angle of the reinforcing cords with respect to the tire circumferential direction (also referred to as the cord angle) is set in a range from, for example, 10° to 40°.

For the purpose of enhancing high-speed durability, at least one layer of a belt cover layer 9 formed by arranging reinforcing cords at an inclination angle of not more than 5° with respect to the tire circumferential direction, is disposed on an outer circumferential side of the belt layer 8. The belt cover layer 9 preferably has a jointless structure in which a strip material made from at least a single reinforcing cord laid in parallel and covered with rubber is wound continuously in the tire circumferential direction. Also, the belt cover layer 9 can be disposed so as to cover the belt layer 8 in the width direction at all positions as illustrated in the drawing, or can be disposed to cover only the edge portions of the belt layer 8 to the outside in the width direction. Cords using organic fibers such as nylon, polyethylene terephthalate (PET), aramid, and the like on their own or in composite can be used as the reinforcing cords of the belt cover layer 9.

In the pneumatic radial tire as described above, monofilament steel wires 10 that have been twisted around their axes (see FIGS. 2 and 3) are used as the reinforcing cords from which the belt layers 8 are configured. In FIG. 3, wire drawing marks 11 caused by the wire drawing are formed on the surface of the monofilament steel wires 10, and the wire surface twisting angle θ with respect to the axial direction of the monofilament steel wires 10 determined based on these wire drawing marks 11 is within the range from 1° to 15°.

As stated above, in the pneumatic radial tire that includes the belt layer 8 in which the plurality of monofilament steel wires 10 is laid in parallel and embedded in rubber, each of the monofilament steel wires 10 is twisted around its axis, and by prescribing that the wire surface twisting angle θ with respect to the axial direction of the monofilament steel wire 10 is within the range prescribed above, the orientation of the metal microstructure in the monofilament steel wires 10 caused by the wire drawing process is reduced, so the fatigue resistance of the monofilament steel wires 10 is improved and the tire durability performance is increased.

Also, when the monofilament steel wires 10 are twisted, the straightness of the monofilament steel wires 10 is excellent, and the accuracy of splicing the belt layer 8 in the tire molding process is improved. This improvement in the straightness of the monofilament steel wires 10 contributes to improving the tire durability performance. As a result, it is possible to reduce the rolling resistance of the pneumatic radial tire based on the use of monofilament steel wires, while maintaining excellent tire durability performance.

In this case, if the wire surface twisting angle θ is less than 1°, the effect of improving the fatigue resistance of the monofilament steel wires 10 is insufficient, and the effect of improving the straightness is also insufficient. Also, if the wire surface twisting angle θ exceeds 15°, the productivity of the monofilament steel wires 10 is reduced.

A commonly used method for controlling the wire surface twisting angle θ within the above range can be used, for example, twisting can be applied using a wire twisting machine.

In the present technology, the wire surface twisting angle θ is measured as follows. First, monofilament steel wire is extracted from the pneumatic radial tire, and the rubber is removed after immersing the wire in an organic solvent and swelling the rubber adhering to the surface. Then, the monofilament steel wire is observed using an optical microscope, the wire strand diameter d (mm) of the monofilament steel wire is measured, 1/2 the value of the twisting pitch P (mm) illustrated in FIG. 2 is measured from the wire drawing marks formed on the wire surface, and this is doubled to obtain the twisting pitch P. The twisting pitch P is the average value of the measurement values of at least 10 positions. The wire surface twisting angle θ is calculated from the following equation (1) based on the wire strand diameter d and the twisting pitch P.

θ=A TAN(π×d/P)×180/π (1)

In the pneumatic radial tire as described above, the surface residual stress σ of the monofilament steel wires 10 from which the belt layer 8 is configured is less than or equal to 0 MPa, preferably is less than 0 MPa, and more preferably is equal to or less than −50 MPa. There is no particular limitation on the method of controlling the surface residual stress σ to be within the above range, and skin pass wire drawing or shot peening or the like can be carried out. For example, Japanese Unexamined Patent Application Publication No. H07-308707, Japanese Unexamined Patent Application Publication No. H08-24938, and Japanese Unexamined Patent Application Publication No. H11-199979 disclose specific methods to make this surface residual stress σ a negative value.

By making the wire surface strain of the monofilament steel wires 10 equal to 0 or on the compressive side, when a tensile strain is produced on the surface of the wire by bending of the monofilament steel wires 10 due to buckling of the tread portion 1, the portion where the tensile strain is produced does not easily break, so it is possible to further increase the effect of improvement of the tire durability performance.

In this case, if the surface residual stress σ of the monofilament steel wires 10 is greater than 0 MPa, when buckling of the tread portion 1 occurs, bending damage can easily occur to the monofilament steel wires 10. In this case, by making the surface residual stress σ less than 0 MPa and the wire surface strain on the compressive side, it is possible to suppress the bending damage of the monofilament steel wires 10. In particular, by making the surface residual stress σ of the monofilament steel wires 10 less than or equal to −50 MPa, it is possible to effectively prevent rupture of the monofilament steel wires 10 due to buckling of the tread portion 1. There is no particular lower limit to the surface residual stress σ of the monofilament steel wires 10, but for example, it may be −2,000 MPa. The surface residual stress σ of the monofilament steel wires 10 is, for example, from 0 MPa to −40 MPa, or from −50 MPa to −105 MPa.

The surface residual stress σ of the monofilament steel wires 10 is measured by a stress measurement method using x-rays. Namely, when the angle ψ formed by the normal line of the test specimen surface and the normal line of the crystal lattice surface is varied, and the variation in the diffraction angle (2θ₁) of the diffraction line is investigated, the surface residual stress σ is obtained from the following equation (2).

$$\begin{matrix}Equation 1 & \\ σ = \frac{E}{2 ( 1 + v )} \cdot cot {θ}_{0} \cdot \frac{π}{180} \cdot \frac{\partial ( 2 {θ}_{1} )}{\partial ( {sin}^{2} φ )} = K \frac{\partial ( 2 {θ}_{1} )}{\partial ( {sin}^{2} φ )} & ( 2 )\end{matrix}$$

where,

σ: Surface residual stress (MPa)

E: Young's modulus of the material (MPa)

ν: Poisson's ratio

θ₀: Standard Bragg angle (°)

K: Stress constant

In the pneumatic radial tire as described above, the wire strand diameter d of the monofilament steel wires 10 is set in the range from 0.30 mm to 0.40 mm. If the wire strand diameter d is less than 0.30 mm, it will be necessary to reduce the spacing between monofilament steel wires 10 in order to ensure the overall strength of the belt layer 8, but if the spacing becomes narrow, cord separation can easily occur in which the monofilament steel wires 10 separate from each other, so the tire durability performance becomes poor. On the other hand, if the wire strand diameter d exceeds 0.40 mm, edge separation can easily occur at the cut ends of the monofilament steel wires 10, so the tire durability performance becomes poor, and, moreover, the belt layer 8 becomes thicker, so the effect of reducing the rolling resistance becomes smaller. Preferably, the wire strand diameter d is from 0.32 to 0.40 mm. Also, the spacing between monofilament steel wires 10 is, for example, from 0.275 mm to 0.483 mm.

In the pneumatic radial tire as described above, preferably, the belt layer 8 is configured so as to satisfy the conditions that the tensile rigidity of the monofilament steel wires 10 per 50 mm width of the belt layers 8 is 1,200 kN/50 mm or more, and is preferably from 1,200 kN/50 mm to 2,200 kN/50 mm; and the out of plane bending rigidity of the monofilament steel wires 10 per 50 mm width of the belt layer 8 is 10,000 N·mm²/50 mm or more, and preferably is from 10,000 N·mm²/50 mm to 22,000 N·mm²/50 mm. More specifically, the material of the monofilament steel wires 10 is appropriately selected, and the wire density of the monofilament steel wires 10 is appropriately adjusted to satisfy the above conditions. The wire density is, for example, from 60 to 90 wires/50 mm.

The tensile rigidity of the monofilament steel wires 10 per 50 mm width of the belt layer 8 is the sum of the tensile rigidity (N) of the monofilament steel wires 10 included per 50 mm width of the belt layers 8 measured along the direction orthogonal to the direction in which the monofilament steel wires 10 extend. Also, the out of plane bending rigidity of the monofilament steel wires 10 per 50 mm width of the belt layers 8 is the sum of the bending rigidity (N·mm²) of the monofilament steel wires 10 included per 50 mm width of the belt layers 8 measured along the direction normal to the direction in which the monofilament steel wires 10 extend.

The tensile rigidity and the out of plane bending rigidity are each obtained from the following equations.

Tensile rigidity (N)=Young's modulus (N/mm²)×wire cross-sectional area (mm²)

Bending rigidity (N·mm²)=(Young's modulus (N/mm²)×π×wire radius (mm)⁴×number of wires (count))/64

By ensuring sufficient tensile rigidity of the monofilament steel wires 10 from which the belt layers 8 are configured as described above, rupture of the monofilament steel wires 10 is prevented, so it is possible to improve the durability of the belt layer 8. In this case, if the tensile rigidity of the monofilament steel wires 10 per 50 mm width of the belt layers 8 is less than 1,200 kN/50 mm, the effect of improving the tire durability performance will be insufficient. On the other hand, by ensuring sufficient out of plane bending rigidity of the monofilament steel wires 10, buckling of the tread portion 1 is suppressed, so it is possible to increase the durability of the belt layer 8. In this case, if the out of plane bending rigidity of the monofilament steel wires 10 per 50 mm width of the belt layer 8 is less than 10,000 N·mm²/50 mm, the effect of improving the tire durability performance will be insufficient.

The tensile rigidity of the monofilament steel wires 10 is, for example, from 1,189 to 1,585 kN/50 mm, and the out of plane bending rigidity of the monofilament steel wires 10 is, for example, from 7,369 to 9,102 kN/50 mm, from 9,102 to 12,136 kN/50 mm, from 14,234 to 14,509 kN/50 mm, or preferably from 10,000 to 14500 kN/50 mm.

In the pneumatic radial tire as described above, preferably, the belt cover layer 9 is wound around the outer circumferential side of at least the edge portion of the belt layer 8. In this way, even if the spacing between the monofilament steel wires 10 is narrow, separation is prevented between the monofilament steel wires 10 and the surrounding rubber, so it is possible to improve the tire durability performance.

The reinforcing cords of the belt cover layer 9 has a total fineness of 1400 dtex/l to 2100 dtex/l, and single direction twist cords made from nylon 66 may be used. When such a single direction twist cord is used, it is possible to reduce the thickness of the belt cover layer 9 compared with double direction twist cords. Therefore, the tire durability performance is improved by the addition of the belt cover layer 9, and the rolling resistance can be reduced by making the belt cover layer 9 thinner. In this case, if the total fineness of the single direction twisted cords is less than 1,400 dtex/l, the effect of improving the tire durability performance is reduced, and conversely, if it exceeds 2,100 dtex/l, the effect of improving the rolling resistance is reduced. Also, by using single direction twist cords made from nylon 66, the adhesive strength and the heat shrinkage stress is greater compared with cords made from other resins, so it is possible to suppress the rising of the tire tread at high speeds.

In the present technology, the monofilament steel wires from which the belt layer is configured are twisted, and by prescribing the wire surface twisting angle, the orientation of the metal microstructure caused by the wire drawing is reduced in the monofilament steel wires, so it is possible to improve the fatigue resistance of the monofilament steel wires, and increase the tire durability performance. Also, when the monofilament steel wires are twisted, the straightness of the monofilament steel wires is excellent, and the improvement in the splice accuracy of the belt layer contributes to improving the tire durability performance. In addition, by making the wire surface strain of the monofilament steel wires equal to 0 MPa or less, in other words, by making the wire surface strain on the compressive side, when a tensile strain is produced on the surface of the wire by bending of the monofilament steel wires due to buckling of the tread portion, the portion where the tensile strain is produced does not easily break, so it is possible to further increase the effect of improvement of the tire durability performance. As a result, it is possible to reduce the rolling resistance of the pneumatic radial tire based on the use of monofilament steel wires, while maintaining excellent tire durability performance.

In the present technology, preferably, the belt layer 8 is configured so as to satisfy the conditions that the tensile rigidity of the monofilament steel wires 10 per 50 mm width of the belt layer 8 is 1,200 kN/50 mm or more, and the out of plane bending rigidity of the monofilament steel wires 10 per 50 mm width of the belt layer 8 is 10,000 N·mm²/50 mm or more. By ensuring sufficient tensile rigidity of the monofilament steel wires, it is possible to prevent rupture of the monofilament steel wires, and by ensuring sufficient out of plane bending rigidity of the monofilament steel wires, it is possible to suppress buckling of the tread portion. These contribute to the improvement in the tire durability performance.

Preferably, the surface residual stress of the monofilament steel wires is −50 MPa or less. By applying a large compressive strain to the wire surface in this way, it is possible to further effectively prevent rupture of the monofilament steel wires due to buckling of the tread portion.

Preferably, the belt cover layer is wound around the outer circumferential side of at least the edge portion of the belt layer. In this way, it is possible to compensate for the disadvantage of using monofilament steel wires, namely, separation can easily occur between the wires and rubber due to the narrow spacing of the wires by the belt cover layer. In particular, preferably, single direction twist cords made from nylon 66 having a total fineness from 1400 dtex/l to 2100 dtex/l are used as the reinforcing cords of the belt cover layer. If single direction twist cords of this type are used, it is possible to reduce the thickness of the belt cover layer, so it is possible to reduce the rolling resistance while maintaining excellent tire durability performance.

### Working Examples

Pneumatic radial tires of tire size 195/65R15, provided with a belt layer in which a plurality of reinforcing cords was laid in parallel and embedded in rubber on the outer circumferential side of the carcass layer in the tread portion, and provided with a belt cover layer made from fiber cords of nylon 66 on the outer circumferential side of the belt layer, were produced as tires of Conventional Example 1, Comparative Examples 1 to 7, and Working Examples 1 to 24, having the belt layer reinforcing cord structure, wire surface twisting angle θ, wire strand diameter d, surface residual stress σ, wire density, wire spacing, wire total cross-sectional area per 50 mm width, tensile rigidity per 50 mm width, out of plane bending rigidity per 50 mm width, and twisting structure of the belt cover layer set as shown in Tables 1 to 5. In Tables 1 to 5, “dtex” is shown as “T” for the twisting structure of the belt cover layer.

The tire of Conventional Example 1 used steel cords with a 1×3 structure having three filaments with wire strand diameter d of 0.28 mm twisted together as the reinforcing cords of the belt layer. On the other hand, the tires of Working Examples 1 to 24 and Comparative Examples 1 to 7 used monofilament steel wires with wire strand diameter d of 0.25 mm to 0.45 mm as the reinforcing cords of the belt layer 8.

The common items for all the test tires included the width of the first belt layer on the inner side in the tire radial direction of 150 mm, the width of the second belt layer on the outer side in the tire radial direction of 140 mm, the cord angle of the first belt layer with respect to the tire circumferential direction of 27°, and the cord angle of the second belt layer with respect to the tire circumferential direction of −27° (27° on the side opposite the first belt layer), and the rubber gauge was the same for all belt cords.

The rolling resistance and the tire durability performance were evaluated for these test tires by the following methods, and the results are also shown on Tables 1 to 5.

### Rolling Resistance:

Each test tire was assembled onto a wheel of rim size of 15×6JJ, the air pressure was set to 230 kPa, and the resistance force of the test tire was measured using a drum-type rolling resistance testing machine with drum diameter of 1707 mm when traveling at a speed of 80 km/h and load of 6.15 kN, and this was taken to be the rolling resistance. Evaluation results were expressed as index values, Conventional Example 1 being assigned an index value of 100. Smaller index values indicate less rolling resistance.

### Tire Durability Performance (Belt Breakage):

Each test tire was assembled onto a wheel of rim size of 15×6JJ and the air pressure was set to 170 kPa, and running tests were carried out on drums of diameter of 1707 mm at 25 km/h with the load and slip angle varying as a square wave. The load was 3.2±2.1 kN, and there were two types of slip angle, 0±2° and 0±5° (0±2° was measured only for Working Examples 9 to 19, and Comparative Examples 6 and 7), and the frequency was varied by 0.067 Hz so that when the slip angle was 2° or 5°, the load was 5.3 kN, and when the slip angle was −2° or −5°, the load was 1.1 kN. Also, after every 5 km traveled, the presence or absence of belt breakage was checked by X-ray, and the running distance until belt breakage was measured. Evaluation results were expressed as index values, Conventional Example 1 being assigned an index value of 100. The higher the index value, the better the tire durability performance.

### Tire Durability Performance (Belt Separation):

Each test tire was assembled onto a wheel of rim size of 15×6JJ and the air pressure was set to 170 kPa, and running tests were carried out on drums of diameter of 1707 mm at 60 km/h with the load and slip angle varying as a square wave. The load was 3.2±2.1 kN, and the slip angle was 0±3°, and the frequency was varied by 0.03 Hz so that when the slip angle was 3°, the load was 5.3 kN, and when the slip angle was −3°, the load was 1.1 kN. Then, after running 6000 km, the tire was dismantled, and the length of belt separation that occurred in the tire was measured. Here, the length of belt separation is the length of edge separation at the cut end of the reinforcing cords. Evaluation results were expressed as index values, Conventional Example 1 being assigned an index value of 100. The smaller the index value, the better the tire durability performance.

TABLE 1

| | | Conventional | Working | Working | Comparative |
|---|---|---|---|---|---|
| | | Example 1 | Example 1 | Example 2 | Example 1 |
| Belt layer | Structure | 1 × 3 | Monofilament | Monofilament | Monofilament |
| reinforcing | Wire surface | — | 3.0 | 3.0 | 3.0 |
| cords | Twisting angle | | | | |
| | θ (°) | | | | |
| | Wire strand | 0.28 | 0.35 | 0.35 | 0.25 |
| | diameter d | | | | |
| | (mm) | | | | |
| | Surface | — | −25 | −25 | −25 |
| | residual stress | | | | |
| | σ (MPa) | | | | |
| | Wire density | 31 | 60 | 80 | 118 |
| | (wires/50 mm) | | | | |
| | Cord | 0.64 | 0.483 | 0.275 | 0.174 |
| | spacing (mm) | | | | |
| | Wire total | 5.73 | 5.77 | 7.70 | 5.79 |
| | cross-sectional | | | | |
| | area | | | | |
| | (mm²/50 mm) | | | | |
| | Tensile | 1179 | 1189 | 1585 | 1193 |
| | rigidity | | | | |
| | (kN/50 mm) | | | | |
| | Out of plane | 5579 | 9102 | 12136 | 4660 |
| | bending | | | | |
| | rigidity | | | | |
| | (Nmm²/50 mm) | | | | |

| | | | | |
|---|---|---|---|---|
| Belt cover layer twisting | 1400T/2 | 1400T/2 | 1400T/2 | 1400T/2 |
| structure | | | | |
| Rolling resistance | 100 | 95 | 95 | 94 |
| Tire durability performance/ | 100 | 108 | 117 | 92 |
| slip angle ±5° | | | | |
| (belt breakage) | | | | |
| Tire durability | 100 | 100 | 100 | 300 |
| (belt separation) | | | | |

| | | Working | Working | Comparative |
|---|---|---|---|---|
| | | Example 3 | Example 4 | Example 2 |
| Belt layer | Structure | Monofilament | Monofilament | Monofilament |
| reinforcing | Wire surface | 3.0 | 3.0 | 3.0 |
| cords | Twisting angle | | | |
| | θ (°) | | | |
| | Wire strand | 0.3 | 0.4 | 0.45 |
| | diameter d (mm) | | | |
| | Surface residual | −25 | −25 | −25 |
| | stress σ (MPa) | | | |
| | Wire density | 90 | 55 | 35 |
| | (wires/50 mm) | | | |
| | Cord | 0.256 | 0.509 | 0.979 |
| | spacing (mm) | | | |
| | Wire total | 6.36 | 6.91 | 5.57 |
| | cross-sectional | | | |
| | area | | | |
| | (mm²/50 mm) | | | |
| | Tensile rigidity | 1310 | 1423 | 1146 |
| | (kN/50 mm) | | | |
| | Out of plane | 7369 | 14234 | 14509 |
| | bending rigidity | | | |
| | (N · mm²/50 mm) | | | |

| | | | |
|---|---|---|---|
| Belt cover layer twisting | 1400T/2 | 1400T/2 | 1400T/2 |
| structure | | | |
| Rolling resistance | 95 | 95 | 96 |
| Tire durability performance/ | 108 | 117 | 108 |
| slip angle ±5° | | | |
| (belt breakage) | | | |
| Tire durability | 100 | 100 | 200 |
| (belt separation) | | | |

TABLE 2

| | | Comparative | Comparative | Working | Working |
|---|---|---|---|---|---|
| | | Example 3 | Example 4 | Example 5 | Example 6 |
| Belt layer | Structure | Monofilament | Monofilament | Monofilament | Monofilament |
| reinforcing | Wire surface | 0 | 0.5 | 1.0 | 7.0 |
| cords | Twisting angle | | | | |
| | θ (°) | | | | |
| | Wire strand | 0.35 | 0.35 | 0.35 | 0.35 |
| | diameter d | | | | |
| | (mm) | | | | |
| | Surface | −25 | −25 | −25 | −25 |
| | residual stress | | | | |
| | σ (MPa) | | | | |
| | Wire density | 60 | 60 | 60 | 60 |
| | (wires/50 mm) | | | | |
| | Cord | 0.483 | 0.483 | 0.483 | 0.483 |
| | spacing(mm) | | | | |
| | Wire total | 5.77 | 5.77 | 5.77 | 5.77 |
| | cross-sectional | | | | |
| | area | | | | |
| | (mm²/50 mm) | | | | |
| | Tensile | 1189 | 1189 | 1189 | 1189 |
| | rigidity | | | | |
| | (kN/50 mm) | | | | |
| | Out of plane | 9102 | 9102 | 9102 | 9102 |
| | bending | | | | |
| | rigidity | | | | |
| | (Nmm²/50 mm) | | | | |

| | | | | |
|---|---|---|---|---|
| Belt cover layer twisting | 1400T/2 | 1400T/2 | 1400T/2 | 1400T/2 |
| structure | | | | |
| Rolling resistance | 95 | 95 | 95 | 95 |
| Tire durability performance/ | 83 | 92 | 108 | 108 |
| slip angle ±5° | | | | |
| (belt breakage) | | | | |
| Tire durability | 100 | 100 | 100 | 100 |
| (belt separation) | | | | |

| | | Working | Working | Comparative |
|---|---|---|---|---|
| | | Example 7 | Example 8 | Example 5 |
| Belt layer | Structure | Monofilament | Monofilament | Monofilament |
| reinforcing | Wire surface | 8.0 | 15.0 | 16.0 |
| cords | Twisting angle θ (°) | | | |
| | Wire strand | 0.35 | 0.35 | 0.35 |
| | diameter d (mm) | | | |
| | Surface residual | −25 | −25 | −25 |
| | stress σ (MPa) | | | |
| | Wire density | 60 | 60 | 60 |
| | (wires/50 mm) | | | |
| | Cord spacing(mm) | 0.483 | 0.483 | 0.483 |
| | Wire total | 5.77 | 5.77 | 5.77 |
| | cross-sectional area | | | |
| | (mm²/50 mm) | | | |
| | Tensile rigidity | 1189 | 1189 | 1189 |
| | (kN/50 mm) | | | |
| | Out of plane | 9102 | 9102 | 9102 |
| | bending rigidity | | | |
| | (Nmm²/50 mm) | | | |

| | | | |
|---|---|---|---|
| Belt cover layer twisting structure | 1400T/2 | 1400T/2 | 1400T/2 |
| Rolling resistance | 95 | 95 | 95 |
| Tire durability performance/slip | 108 | 108 | 108 |
| angle ±5° | | | |
| (belt breakage) | | | |
| Tire durability | 100 | 100 | 100 |
| (belt separation) | | | |

TABLE 3

| | | Comparative | Comparative | Working | Working |
|---|---|---|---|---|---|
| | | Example 6 | Example 7 | Example 9 | Example 10 |
| Belt | Structure | Monofilament | Monofilament | Monofilament | Monofilament |
| layer | Wire surface | 3.0 | 3.0 | 3.0 | 3.0 |
| reinforcing | Twisting angle | | | | |
| cords | θ (°) | | | | |
| | Wire strand | 0.35 | 0.35 | 0.35 | 0.35 |
| | diameter d | | | | |
| | (mm) | | | | |
| | Surface residual | +250 | +20 | 0 | −10 |
| | stress σ (MPa) | | | | |
| | Wire density | 60 | 60 | 60 | 60 |
| | (wires/50 mm) | | | | |
| | Cord spacing | 0.483 | 0.483 | 0.483 | 0.483 |
| | (mm) | | | | |
| | Wire total | 5.77 | 5.77 | 5.77 | 5.77 |
| | cross-sectional | | | | |
| | area | | | | |
| | (mm²/50 mm) | | | | |
| | Tensile rigidity | 1189 | 1189 | 1189 | 1189 |
| | (kN/50 mm) | | | | |
| | Out of plane | 9102 | 9102 | 9102 | 9102 |
| | bending rigidity | | | | |
| | (N · mm²/50 mm) | | | | |
| Belt cover layer twisting | | 1400T/2 | 1400T/2 | 1400T/2 | 1400T/2 |
| structure | | | | | |
| Rolling resistance | | 95 | 95 | 95 | 95 |
| Tire | Tire durability | 92 | 100 | 100 | 108 |
| durability | performance/ | | | | |
| (belt | slip angle ±2° | | | | |
| breakage) | Slip angle ±5° | 92 | 92 | 100 | 100 |

| | | | | |
|---|---|---|---|---|
| Tire durability | 100 | 100 | 100 | 100 |
| (belt separation) | | | | |

| | | | Working | Working | Working |
|---|---|---|---|---|---|
| | | | Example 11 | Example 12 | Example 13 |
| Belt layer | | Structure | Monofilament | Monofilament | Monofilament |
| reinforcing | | Wire surface | 3.0 | 3.0 | 3.0 |
| cords | | Twisting angle θ (°) | | | |
| | | Wire strand | 0.35 | 0.35 | 0.35 |
| | | diameter d (mm) | | | |
| | | Surface residual | −25 | −40 | −50 |
| | | stress σ (MPa) | | | |
| | | Wire density | 60 | 60 | 60 |
| | | (wires/50 mm) | | | |
| | | Cord spacing (mm) | 0.483 | 0.483 | 0.483 |
| | | Wire total | 5.77 | 5.77 | 5.77 |
| | | cross-sectional area | | | |
| | | (mm²/50 mm) | | | |
| | | Tensile rigidity | 1189 | 1189 | 1189 |
| | | (kN/50 mm) | | | |
| | | Out of plane | 9102 | 9102 | 9102 |
| | | bending rigidity | | | |
| | | (N · mm²/50 mm) | | | |
| | Belt cover layer twisting | | 1400T/2 | 1400T/2 | 1400T/2 |
| | structure | | | | |
| | Rolling resistance | | 95 | 95 | 95 |
| | Tire durability | Tire durability | 108 | 117 | 117 |
| | (belt breakage) | performance/ | | | |
| | | slip angle ±2° | | | |
| | | Slip angle ±5° | 100 | 100 | 117 |

| | | | |
|---|---|---|---|
| Tire durability | 100 | 100 | 100 |
| (belt separation) | | | |

TABLE 4

| | | Working | Working | Working |
|---|---|---|---|---|
| | | Example 14 | Example 15 | Example 16 |
| Belt layer | Structure | Monofilament | Monofilament | Monofilament |
| reinforcing | Wire surface | 3.0 | 3.0 | 3.0 |
| cords | Twisting angle θ (°) | | | |
| | Wire strand | 0.35 | 0.35 | 0.35 |
| | diameter d (mm) | | | |
| | Surface residual | −60 | −70 | −80 |
| | stress σ (MPa) | | | |
| | Wire density | 60 | 60 | 60 |
| | (wires/50 mm) | | | |
| | Cord spacing (mm) | 0.483 | 0.483 | 0.483 |
| | Wire total | 5.77 | 5.77 | 5.77 |
| | cross-sectional area | | | |
| | (mm²/50 mm) | | | |
| | Tensile rigidity | 1189 | 1189 | 1189 |
| | (kN/50 mm) | | | |
| | Out of plane | 9102 | 9102 | 9102 |
| | bending rigidity | | | |
| | (N · mm²/50 mm) | | | |
| Belt cover layer twisting structure | | 1400T/2 | 1400T/2 | 1400T/2 |
| Rolling resistance | | 95 | 95 | 95 |
| Tire durability | Slip angle ±2° | 117 | 117 | 125 |
| (belt breakage) | Slip angle ±5° | 117 | 117 | 117 |
| Tire durability | | 100 | 100 | 100 |
| (belt separation) | | | | |
| | | Working | Working | Working |
| | | Example 17 | Example 18 | Example 19 |
| Belt layer | Structure | Monofilament | Monofilament | Monofilament |
| reinforcing | Wire surface | 3.0 | 3.0 | 3.0 |
| cords | Twisting angle θ (°) | | | |
| | Wire strand | 0.35 | 0.35 | 0.35 |
| | diameter d (mm) | | | |
| | Surface residual | −90 | −90 | −105 |
| | stress σ (MPa) | | | |
| | Wire density | 60 | 60 | 60 |
| | (wires/50 mm) | | | |
| | Cord spacing (mm) | 0.483 | 0.483 | 0.483 |
| | Wire total | 5.77 | 5.77 | 5.77 |
| | cross-sectional area | | | |
| | (mm²/50 mm) | | | |
| | Tensile rigidity | 1189 | 1189 | 1189 |
| | (kN/50 mm) | | | |
| | Out of plane | 9102 | 9102 | 9102 |
| | bending rigidity | | | |
| | (N · mm²/50 mm) | | | |
| Belt cover layer twisting structure | | 1400T/2 | 1400T/2 | 1400T/2 |
| Rolling resistance | | 95 | 95 | 95 |
| Tire durability | Slip angle ±2° | 125 | 133 | 133 |
| (belt breakage) | Slip angle ±5° | 117 | 125 | 117 |

| | | | |
|---|---|---|---|
| Tire durability | 100 | 100 | 100 |
| (belt separation) | | | |

TABLE 5

| | | Working | Working | Working |
|---|---|---|---|---|
| | Working Examples | Example 20 | Example 21 | Example 22 |
| Belt layer | Structure | Monofilament | Monofilament | Monofilament |
| reinforcing | Wire surface | 3.0 | 3.0 | 3.0 |
| cords | Twisting angle θ (°) | | | |
| | Wire strand diameter d | 0.35 | 0.35 | 0.35 |
| | (mm) | | | |
| | Surface residual stress | −90 | −90 | −90 |
| | σ (MPa) | | | |
| | Wire density | 80 | 80 | 80 |
| | (wires/50 mm) | | | |
| | Cord spacing (mm) | 0.275 | 0.275 | 0.275 |
| | Wire total | 7.70 | 7.70 | 7.70 |
| | cross-sectional area | | | |
| | (mm²/50 mm) | | | |
| | Tensile rigidity | 1585 | 1585 | 1585 |
| | (kN/50 mm) | | | |
| | Out of plane bending | 12136 | 12136 | 12136 |
| | rigidity | | | |
| | (N · mm²/50 mm) | | | |

| | | | |
|---|---|---|---|
| Belt cover layer twisting structure | 940T/1 | 1400T/1 | 1880T/1 |
| Rolling resistance | 88 | 90 | 92 |
| Tire durability performance/slip | 100 | 125 | 125 |
| angle ±5° (belt breakage) | | | |
| Tire durability | 200 | 100 | 100 |
| (belt separation) | | | |

| | | Working | Working |
|---|---|---|---|
| | Working Examples | Example 23 | Example 24 |
| Belt layer | Structure | Monofilament | Monofilament |
| reinforcing | Wire surface | 3.0 | 3.0 |
| cords | Twisting angle θ (°) | | |
| | Wire strand diameter d (mm) | 0.35 | 0.35 |
| | Surface residual stress σ | −90 | −90 |
| | (MPa) | | |
| | Wire density | 80 | 80 |
| | (wires/50 mm) | | |
| | Cord spacing (mm) | 0.275 | 0.275 |
| | Wire total cross-sectional area | 7.70 | 7.70 |
| | (mm²/50 mm) | | |
| | Tensile rigidity | 1585 | 1585 |
| | (kN/50 mm) | | |
| | Out of plane bending rigidity | 12136 | 12136 |
| | (N · mm²/50 mm) | | |

| | | |
|---|---|---|
| Belt cover layer twisting structure | 2100T/1 | 2800T/1 |
| Rolling resistance | 93 | 95 |
| Tire durability performance/slip angle ±5° | 125 | 125 |
| (belt breakage) | | |
| Tire durability | 100 | 100 |
| (belt separation) | | |

As can be seen from Tables 1 to 5, the tires of the Working Examples 1 to 24 had lower rolling resistance while maintaining excellent tire durability performance, compared with Conventional Example 1. In particular, the tires of Working Examples 13 to 19 had excellent tire durability performance at slip angle 0±5°, under more severe conditions. The following can be considered in this regard. For a slip angle of 0±2°, the magnitude of the input (stress) is small, so there is an effect on belt breakage even when the residual stress on the compressive side is only small; in contrast, for a slip angle of 0±5°, the magnitude of the input (stress) is large, so if the residual stress on the compressive side is not −50 MPa or lower, it is not possible to obtain a large effect with respect to belt breakage.

Also, with the tires of Working Examples 1 to 24, the belt separation was about the same as that of Conventional Example 1, even though the cord count of the reinforcing cords was large compared with Conventional Example 1.

In contrast, although a rolling resistance reduction effect was found for the tires of Comparative Examples 1 to 7, the tire durability performance was reduced. In particular, in Comparative Example 3, twisting was not applied to the monofilament steel wires of the belt layer, so the tire durability performance was poor. In Comparative Example 4, the wire surface twisting angle θ of the monofilament steel wires was too small, so the tire durability performance was poor. In Comparative Example 5, the wire surface twisting angle θ of the monofilament steel wires was too large, so time was required to produce the test tire. In Comparative Example 1, the wire strand diameter d of the monofilament steel wires was too small, so there was distinct cord separation of the belt layer, and the tire durability performance was poor. In Comparative Examples 6 and 7, the surface residual stress σ of the monofilament steel wires was greater than 0 MPa, so the durability of the belt layer was low, and the tire durability performance was poor. In Comparative Example 2, the wire strand diameter d of the monofilament steel wires was too large, so there was distinct edge separation of the belt layer, and the tire durability performance was poor.

1. A pneumatic radial tire, comprising:
a pair of bead portions;
a pair of side wall portions; and
a tread portion in which a carcass layer is mounted between the pair of bead portions, and a belt layer that includes a plurality of monofilament steel wires laid in parallel and embedded in rubber is disposed between the pair of side wall portions on an outer circumferential side in the tread portion,
the wire strand diameter of the monofilament steel wires being from 0.30 mm to 0.40 mm,
each of the monofilament steel wires being twisted around an axial direction of the monofilament steel wires, with a wire surface twisting angle of 1° to 15° with respect to the axial direction of the monofilament steel wires, and
a surface residual stress of the monofilament steel wires being 0 MPa or less.

2. The pneumatic radial tire according to claim 1, wherein the belt layer is configured so as to satisfy the conditions that a tensile rigidity of the monofilament steel wires per 50 mm width of the belt layer is 1,200 kN/50 mm or more, and an out of plane bending rigidity per 50 mm width of the belt layer is 10,000 N·mm²/50 mm or more.

3. The pneumatic radial tire according to claim 1, wherein the surface residual stress of the monofilament steel wires is −50 MPa or less.

4. The pneumatic radial tire according to claim 1, wherein the belt cover layer is wound around the outer circumferential side of at least an edge portion of the belt layer.

5. The pneumatic radial tire according to claim 4, wherein single direction twist cords made from nylon 66 having a total fineness of 1,400 dtex/l to 2,100 dtex/l are used as reinforcing cords of the belt cover layer.

6. The pneumatic radial tire according to claim 2, wherein the surface residual stress of the monofilament steel wires is −50 MPa or less.

7. The pneumatic radial tire according to claim 2, wherein the belt cover layer is wound around the outer circumferential side of at least an edge portion of the belt layer.

8. The pneumatic radial tire according to claim 7, wherein single direction twist cords made from nylon 66 having a total fineness of 1,400 dtex/l to 2,100 dtex/l are used as reinforcing cords of the belt cover layer.

9. The pneumatic radial tire according to claim 3, wherein the belt cover layer is wound around the outer circumferential side of at least an edge portion of the belt layer.

10. The pneumatic radial tire according to claim 9, wherein single direction twist cords made from nylon 66 having a total fineness of 1,400 dtex/l to 2,100 dtex/l are used as reinforcing cords of the belt cover layer.

11. The pneumatic radial tire according to claim 1, wherein the wire strand diameter of the monofilament steel wires is from 0.32 mm to 0.40 mm.

12. The pneumatic radial tire according to claim 1, wherein a spacing between the monofilament steel wires is from 0.275 mm to 0.483 mm.

13. The pneumatic radial tire according to claim 1, wherein the belt layer is configured so as to satisfy the conditions that a tensile rigidity of the monofilament steel wires per 50 mm width of the belt layer is from 1,200 kN/50 mm to 2,200 kN/50 mm, and an out of plane bending rigidity per 50 mm width of the belt layer is from 10,000 N·mm2/50 mm to 22,000 N·mm2/50 mm.

14. The pneumatic radial tire according to claim 1, wherein the belt layer is configured so as to satisfy the conditions that a tensile rigidity of the monofilament steel wires per 50 mm width of the belt layer is from 1,189 kN/50 mm to 1,585 kN/50 mm.

15. The pneumatic radial tire according to claim 14, wherein an out of plane bending rigidity per 50 mm width of the belt layer is from 7,369 to 9,102 kN/50 mm.

16. The pneumatic radial tire according to claim 14, wherein an out of plane bending rigidity per 50 mm width of the belt layer is from 9,102 to 12,136 kN/50 mm.

17. The pneumatic radial tire according to claim 14, wherein an out of plane bending rigidity per 50 mm width of the belt layer is from 14,234 to 14,509 kN/50 mm.

18. The pneumatic radial tire according to claim 14, wherein an out of plane bending rigidity per 50 mm width of the belt layer is from 10,000 to 14500 kN/50 mm.
